(19) United States
(12) Patent Application Publication
(10) Pub. No.: US 2008/0198397 A1
(43) Pub. Date: Aug. 21, 2008

(54) IMAGE FORMING APPARATUS AND CONTROL METHOD

(76) Inventor: Yoshiaki WATANABE, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/033,424

(22) Filed: Feb. 19, 2008

(30) Foreign Application Priority Data
Feb. 19, 2007 (JP) 2007-038049

(51) Int. Cl. G06F 15/00

(52) U.S. Cl. 358/1.14

(57) ABSTRACT

An image forming apparatus is equipped with a print unit, a recording medium, a recording medium controller, and a power-saving controller. The print unit performs a printing operation. The recording medium temporarily stores an image and information. The recording medium controller controls the recording medium. The power-saving controller supplied independently with power controls a power-saving function of the image forming apparatus, and independently returns functions of the image forming apparatus from a power-saving state to a normal power state. Furthermore, the power-saving controller returns the print unit and the recording medium controller from the power-saving state to the normal power state when receiving data including a print request through the network unit. Alternatively, the power-saving controller returns the recording medium controller from the power-saving state to the normal power state when receiving data including an access request to the recording medium through the network unit.

### CROSS-REFERENCE TO RELATED APPLICATIONS

This patent application is based on and claims priority pursuant to 35 U.S.C. §119 from Japanese Patent Application No. JP2007-038049 filed on Feb. 19, 2007 in the Japan Patent Office, the entire contents of which is hereby incorporated herein by reference.

### BACKGROUND OF THE INVENTION

1. Field of the Invention

Exemplary aspects of the present invention generally relate to an image forming apparatus, and more particularly, to an image forming apparatus that allows each function to smoothly recover from a power-saving state to a normal power state, and a method allowing each function of an image forming apparatus to smoothly recover from a power-saving state to a normal power state.

2. Description of the Background Art

In recent years, a multi-function digital image forming apparatus equipped with a plurality of functions such as a copy function, facsimile function, and a printer function has become practical. With introduction of high-speed CPUs and installation of large-capacity recording media, more and varied printing functions are being added to such a digital image forming apparatus.

In such an image forming apparatus, when a user does not use the image forming apparatus for a certain period of time, and/or the image forming apparatus does not receive a print command from an external device for a certain period of time, the image forming apparatus enters a standby state, and after a certain period of time the image forming apparatus shifts to a power-saving state.

When detecting a predetermined event, for example, when detecting an operation by a user, the image forming apparatus returns from the power-saving state to a normal power state.

The power-saving state described herein refers to a state of the apparatus in which the power supply to functions other than the functions necessary for returning to the normal power state is shut off. Accordingly, the power consumption can be significantly reduced.

The normal power state described herein refers to a state of the apparatus in which the power is supplied to an entire apparatus so that a normal operation of the apparatus can be performed.

Depending on a level of power saving, a plurality of power saving modes can be set.

As the number of functions in the multi-function image forming apparatus increases, the functions to be controlled increase accordingly, necessitating more time for the multi-function image forming apparatus to return from the power-saving state to the normal power state.

Conventionally, when the image forming apparatus receives an event that causes power resumption from the power saving state, a controller in the image forming apparatus mainly performs all the power resumption operation. The power resumption operation of the entire image forming apparatus is performed after a controller system is returned from the power saving state, thereby necessitating time for the image forming apparatus to return from the power saving state to the normal state.

### SUMMARY OF THE INVENTION

In view of the foregoing, exemplary embodiments of the present invention provide an image forming apparatus that allows each function to smoothly recover from a power-saving state to a normal power state.

In one exemplary embodiment, an image forming apparatus includes an operation display unit, a print unit, a reading unit, a recording medium, a recording medium controller, a network unit, an operating input detection unit, and a power-saving controller.

The operation display unit accepts operating input through operation keys and display devices. The print unit performs a printing operation. The reading unit reads a document image. The recording medium temporarily stores an image and information. The recording medium controller controls the recording medium. The network unit communicates with an external device. The operating input detection unit detects operation by the user. The power-saving controller supplied independently with power controls a power-saving function of the image forming apparatus, and independently returns functions of the image forming apparatus from a power-saving state to a normal power state.

Another exemplary embodiment provides the power-saving controller that returns the print unit and the recording medium controller from the power-saving state to the normal power state when receiving data including a print request through the network unit.

Yet another exemplary embodiment provides a method for controlling an image forming apparatus. The method includes accepting operating input through operation keys and display devices; performing printing; reading a document image; storing temporarily an image and information; controlling the storing; communicating with an external device; detecting operating input; and controlling a power-saving function of the image forming apparatus while being independently supplied with power. The controlling includes independently returning functions of the image forming apparatus from a power-saving state to a normal power state.

Yet another and further exemplary embodiment provides an image forming apparatus that includes operation display means for accepting operating input through operation keys and display devices; print means for performing a printing operation; reading means for reading a document image; recording means for temporarily storing an image and information; recording medium control means for controlling the recording means; network means for communicating with an external device; a user operation detection means for detecting an operation by the user; and power-saving control means for controlling a power-saving function of the image forming apparatus while being independently supplied with power.

The power-saving control means independently returns functions of the image forming apparatus from a power-saving state to a normal power state.

Additional features and advantages of the present invention will be more fully apparent from the following detailed description of exemplary embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of exemplary embodiments when considered in connection with the accompanying drawings, wherein:

FIG. 1 is a block diagram illustrating an exemplary structure of an image forming apparatus, according to an exemplary embodiment of the present invention;

FIG. 2 is a block diagram illustrating one example of a software configuration associated with a power-saving function of the image forming apparatus of FIG. 1, according to an exemplary embodiment of the present invention;

FIG. 3 is a diagram illustrating one example of a power-saving state including a plurality of transition stages, according to an exemplary embodiment of the present invention;

FIG. 4 is a sequence diagram illustrating an operation at a suspended state ST5 when receiving print data, according to an exemplary embodiment of the present invention;

FIG. 5 is a sequence diagram illustrating an operation at the suspended state ST5 when receiving a request to access a magnetic disk device 9, according to an exemplary embodiment;

FIG. 6 is a sequence diagram illustrating one example operation when an error occurs, according to an exemplary embodiment;

FIG. 7 is a sequence diagram illustrating another example operation when an error occurs, according to an exemplary embodiment;

FIG. 8 is a sequence diagram illustrating one example operation when an error occurs in a power-saving monitoring system 22a, according to an exemplary embodiment; and

FIG. 9 is a schematic diagram illustrating one example of an alert screen, according to an exemplary embodiment.

### DETAILED DESCRIPTION OF EXEMPLARY EMBODIMENTS

It will be understood that if an element or layer is referred to as being “on,” “against,” “connected to” or “coupled to” another element or layer, then it can be directly on, against connected or coupled to the other element or layer, or intervening elements or layers may be present.

In contrast, if an element is referred to as being “directly on,” “directly connected to” or “directly coupled to” another element or layer, then there are no intervening elements or layers present. Like numbers refer to like elements throughout figures. As used herein, the term “and/or” includes any and all combinations of one or more of the associated listed items.

Spatially relative terms, such as “beneath,” “below,” “lower,” “above,” “upper” and the like, may be used herein for ease of description to describe an element or an element's feature or relationship to another element(s) or feature(s) as illustrated in the figures.

It will be understood that the spatially relative terms are intended to encompass different orientations of the device in use or operation in addition to the orientation depicted in the figures.

For example, if the device in the figures is turned over, elements described as “below” or “beneath” other elements or features would then be oriented “above” the other elements or features. Thus, the term such as “below” can encompass both an orientation of above and below.

The device may be otherwise oriented at various angles (i.e. rotated 90 degrees or at other orientations), and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms.

These terms are used only to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Exemplary embodiments of the present invention are now explained below with reference to the accompanying drawings.

In the later described comparative example, exemplary embodiment, and alternative example, for the sake of simplicity of drawings and descriptions, the same reference numerals will be given to constituent elements such as parts and materials having the same functions, and the descriptions thereof will be omitted unless otherwise stated.

Typically, but not necessarily, paper is the medium from which is made a sheet on which an image is to be formed. Other printable media are available in sheets and their use here is included. For simplicity, this Detailed Description section refers to paper, sheets thereof, paper feeder, etc. It should be understood, however, that the sheets, etc., are not limited only to paper.

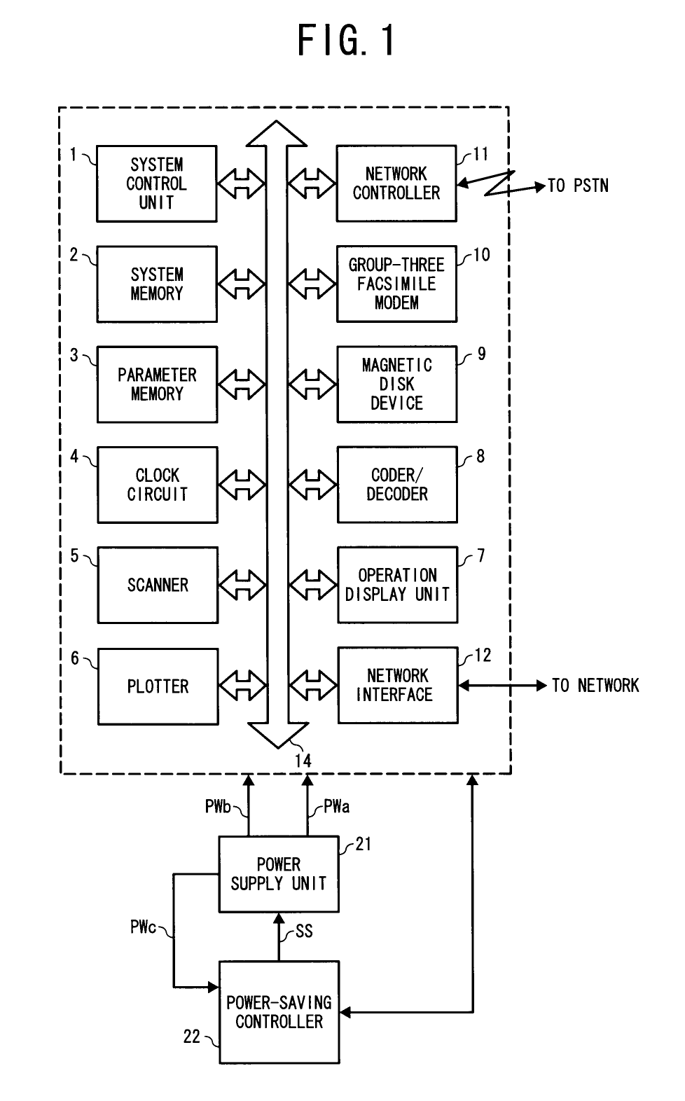

Referring now to the drawings, wherein like reference numerals designate identical or corresponding parts throughout the several views, particularly to FIG. 1, an image forming apparatus according to an exemplary embodiment of the present invention is described.

FIG. 1 is a schematic diagram illustrating one exemplary structure of the image forming apparatus according to an exemplary embodiment of the present invention.

The image forming apparatus is integrally equipped with at least a document image reading function, an image printing function, a copy function, a network communication function, and a network printer function. Furthermore, the image forming apparatus separately includes a power-saving controller. The power-saving controller is configured to control a power saving function of the image forming apparatus. A description thereof will be provided later.

In FIG. 1, a system control unit 1 is configured to control processing of each device of the image forming apparatus and facsimile transmission.

A system memory 2 is configured to store control processing programs executed by the system control unit 1 and various types of data necessary when the system control unit 1 executes the control processing programs. The system memory 2 forms a work area of the system control unit 1.

A parameter memory 3 is configured to store various kinds of information of the image forming apparatus.

A clock circuit 4 is configured to output current time information.

A scanner 5 is configured to read a document image at a predetermined resolution.

A plotter 6 is configured to output the image at a predetermined resolution. For example, the plotter 6 is equipped with a printer engine using an electrophotographic process. Therefore, the printer engine of the plotter 6 is equipped with a thermal fixing device which fixes a toner image transferred onto a print sheet.

An operation display unit 7 is used to operate the image forming apparatus, and includes various kinds of operation keys and display devices.

A coder/decoder 8 is configured to encode and compress image signals, and decode the coded compressed image information to the original image signals.

A magnetic disk device 9 serving as a recording medium is configured to store the encoded-compressed image information and other appropriate data files.

A group-three facsimile modem 10 is configured to implement a modem function of the group-three facsimile. The group-three facsimile modem 10 includes at least a low-speed modem function (V.21 modem) for transmission and exchange of transmission procedure signals, and high-speed modems (V.17 modem, V.34 modem, V.29 modem and V.27 ter modem) for transmission and exchange mainly of image information.

A network controller 11 is configured to connect the image forming apparatus with an analogue public switched telephone network (PSTN) and is equipped with an automatic transmission function.

A network interface circuit 12 is configured to connect the image forming apparatus with a network such as a local area network (LAN) and/or the Internet.

The system control unit 1, the system memory 2, the parameter memory 3, the clock circuit 4, the scanner 5, the plotter 6, the operation display unit 7, the coder/decoder 8, the magnetic disk device 9, the group-three facsimile modem 10, the network controller 11 and the network interface circuit 12 are connected to an internal bus 14. Transmission and exchange of data between each of the above-described devices are performed through the internal bus 14.

However, the network controller 11 and the group-three facsimile modem 10 directly transmit and exchange data between each other.

A power supply unit 21 is configured to supply power to the image forming apparatus, and creates three types power sources: PWa, PWb, and PWc.

The power source PWa is supplied to devices being operated when the image forming apparatus is in the power-saving state. The power source PWb is supplied to devices being operated when the image forming apparatus is in the normal power state. The power source PWc is supplied to a power-saving controller 22.

Under the control of the power-saving controller 22, the power sources PWa, PWb, and PWc are turned on and off.

The power sources PWa and PWc are supplied at all times. The power source PWb is supplied at the normal power state.

Normally, an alternating current power supply, not shown, is supplied to a fixing heater provided to the plotter engine of the plotter 6 by a different system. The alternating current power supply is turned on and off by the power supply unit 21.

According to the exemplary embodiment, when the image forming apparatus returns from the power-saving state to the normal power state, the devices to be referenced are the operation display unit 7 including the power supply key and arbitrary key operations, the network controller 11 for receiving operation, and the network interface circuit 12 for receiving various requests by way of network.

The power-saving controller 22 is configured to control the power-saving function of the image forming apparatus. The power-saving controller 22 is supplied with the power source PWc from the power supply unit 21 at all times so as to be able to operate. The power-saving controller 22 transmits and exchanges necessary information with the image forming apparatus so that the power state of the image forming apparatus is regulated from the power-saving state to the normal power state or vice-versa.

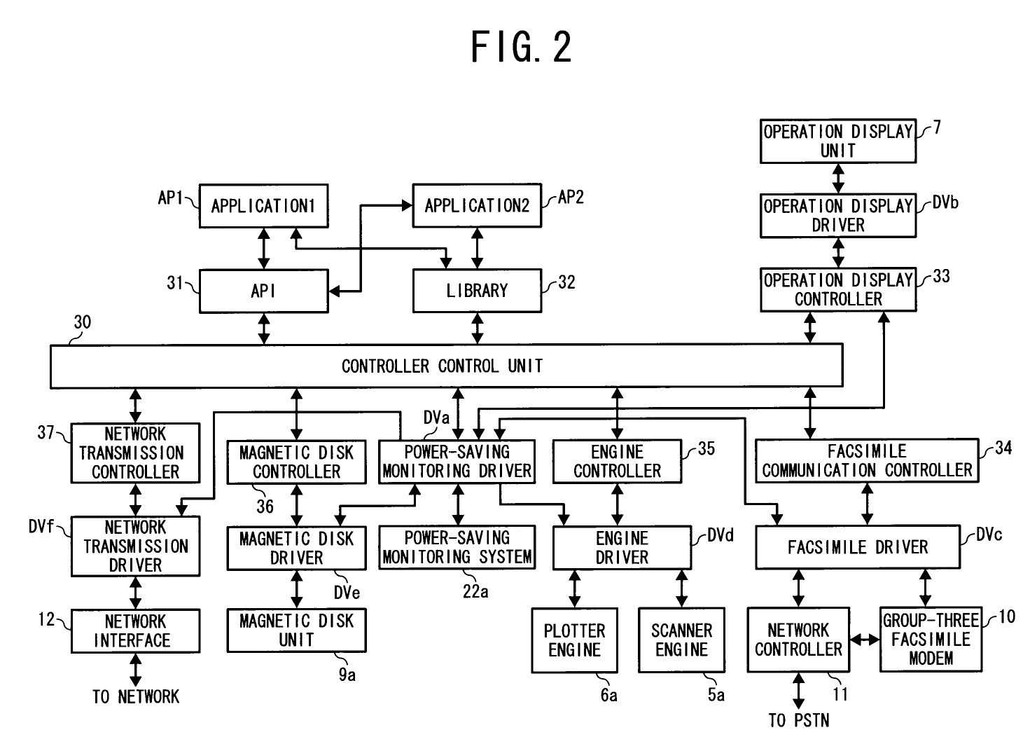

Referring now to FIG. 2, there is provided a block diagram illustrating a structure of software associated with the power-saving function of the image forming apparatus shown in FIG. 1. In FIG. 2, the same reference numerals used in FIG. 1 are given to constituent elements such as parts and devices having the same functions, and the descriptions thereof are omitted.

In FIG. 2, a controller control unit 30 handles system control performed by the system control unit 1. Applications AP1 and AP2 serve as applications which implement various operational functions of the image forming apparatus. The applications AP1 and AP2 include, for example, a facsimile application, a scan-to-email application, a network printer application, an email application, a Web service application (Web server), and so forth.

The applications AP1 and AP2 exchange various information with the controller control unit 30 through an API 31 and a library 32, thereby executing each operational function.

An operation display controller 33 is configured to control the operation display unit 7. The operation display controller 33 exchanges various data with the operation display unit 7 through an operation display driver DVb.

A facsimile communication controller 34 is configured to control a facsimile communication operation. The facsimile communication controller 34 exchanges various data with the group-three facsimile modem 10 and the network controller 11 through a facsimile driver DVc.

An engine controller 35 controls a printing operation of a plotter engine 6a of the plotter 6, and a document image reading operation of a scanner engine 5a of the scanner 5. The engine controller 35 exchanges various data with the plotter engine 6a and the scanner engine 5a through an engine driver DVd.

A magnetic disk controller 36 serving as a recording medium controller controls an operation of a magnetic disk unit 9a of the magnetic disk device 9. The magnetic disk controller 36 exchanges various data with the magnetic disk unit 9a through a magnetic disk driver DVe.

A network transmission controller 37 controls an operation of the network interface circuit 12. The network transmission controller 37 exchanges various data with the network interface circuit 12 through a network transmission driver DVf.

A power-saving monitoring system 22a serves as a software element of the power-saving controller 22. The power-saving monitoring system 22a exchanges various data with the controller control unit 30 through a power-saving monitoring driver DVa.

Furthermore, the power-saving monitoring system 22a exchanges various data with the operation display controller 33, the facsimile driver DVc, the engine driver DVd, the magnetic disk driver DVe, and the network transmission driver DVf.

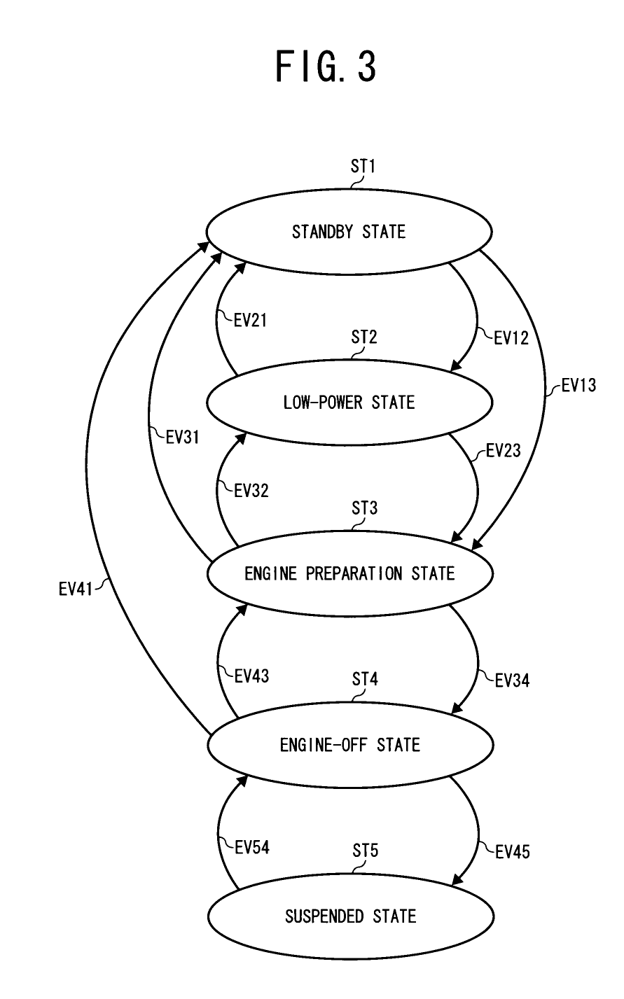

According to the exemplary embodiment, the power-saving state of the image forming apparatus consists of a plurality of different states. With reference to FIG. 3, one example of a state transition between the different states is illustrated.

In FIG. 3, a standby state ST1 is a state in which no operation is performed by the image forming apparatus in the normal power state.

A low-power state ST2 is a power-saving state in association with the International ENERGY STAR Program. The power-saving state herein refers to, for example, 223 W or less (Refer to: http://www.eccj.or.jp/ene-star/prog/p6.html).

An engine preparation state ST3 is a state in which the operation of the peripheral devices is stopped, and the magnetic disk device 9 is operated.

An engine-off state ST4 is a state in which the fixing heater of the plotter engine 6a is turned off, and the magnetic disk device 9 is also turned off.

A suspended state ST5 is a state in which each function is stopped in order to satisfy a standard value of a sleep mode in association with the International ENERGY STAR Program. The standard value herein refers to, for example, 95 W or less.

In the suspended state ST5, the power supply unit 21 basically supplies the power sources PWa and PWc. Accordingly, the power-saving controller 22 and the device elements which detect the recovery from the power-saving state are supplied with power.

In FIG. 3, a transition event EV12 from the standby state ST1 to the low-power state ST2 includes an event in which the standby state takes place for a certain period of time, or an event in which a low-power key, not shown, of the operation display unit 7 is operated.

A transition event EV13 from the standby state ST1 to the engine preparation state ST3 includes events in which, for example, the standby state takes place for a certain period of time, the power supply key is pressed, a power-saving transition request is received from the controller control unit 30, and so forth.

A transition event EV23 from the low-power state ST2 to the engine preparation state ST3, a transition event EV34 from the engine preparation state ST3 to the engine-off state ST4, and a transition event EV45 from the engine-off state ST4 to the suspended state ST5 each include an event in which the original state prior to the transition takes place for a certain period of time, or the like.

A transition event EV54 from the suspended state ST5 to the engine-off state ST4 includes events in which, for example, a request for recovery from the power-saving is made, the power supply key is depressed, the operation display unit 7 detects an operation, and so forth.

A transition event EV41 from the engine-off state ST4 to the standby state ST1 includes events in which, for example, the image forming apparatus is activated by an operation reservation timer such as a schedule timer, the power supply key is depressed, the operation display unit 7 detects an operation, and so forth.

A transition event EV43 from the engine-off state ST4 to the engine preparation state ST3 includes an event in which the request for recovery from the power-saving is made or the like.

A transition event 31 from the engine preparation state ST3 to the standby state ST1 includes events in which the image forming apparatus is activated by the operation reservation timer such as the schedule timer, the power supply key is depressed, the request for recovery from the power-saving is made, and so forth.

A transition event 32 from the engine preparation state ST3 to the low-power state ST2 includes events in which the image forming apparatus is activated by the operation reservation timer such as the schedule timer, the request for recovery from the power-saving is made, and so forth.

A transition event 21 from the low-power state ST2 to the standby state ST1 includes events in which the image forming apparatus is activated by the operation reservation timer such as the schedule timer, the power supply key is depressed, the request for recovery from the power-saving is made, and so forth.

Therefore, when, for example, the image forming apparatus is not in operation for an extended period of time, and the image forming apparatus does not receive a print request from outside and/or a file access request (by the Web server), the state of the image forming apparatus sequentially switches from the standby state ST1, the low-power state ST2, the engine preparation state ST3, the engine-off state ST4, and to the suspended state ST5.

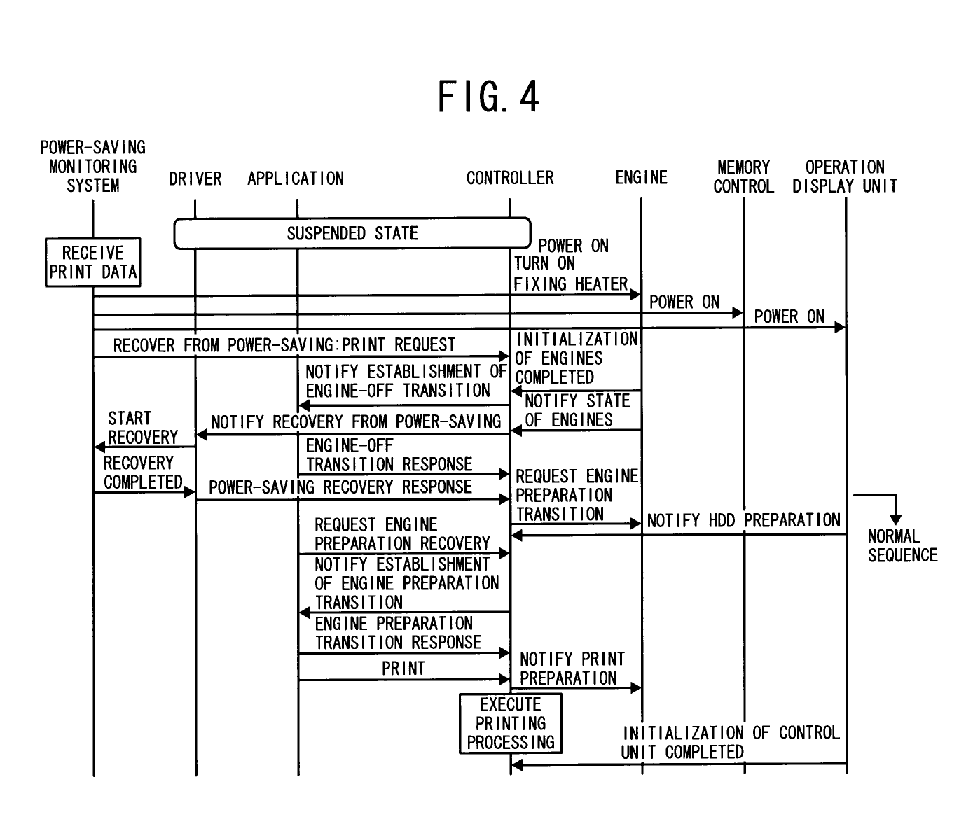

When the image forming apparatus receives print data during the suspended state ST5, the operation state of the image forming apparatus returns from the suspended state ST5 in accordance with a procedure as shown in FIG. 4. Accordingly, the printing operation is resumed.

When the power-saving monitoring system 22a is notified of receipt of the print data from the network transmission driver DVf, the power-saving monitoring system 22a first supplies power to the plotter engine 6a and to the fixing heater, and subsequently the magnetic disk device 9 and the control display unit 7.

Subsequently, the power-saving monitoring system 22a notifies the controller control unit 30 of “RECOVER FROM POWER-SAVING: PRINT REQUEST IS MADE.”

Accordingly, the plotter engine 6a is initialized. When the initialization of the plotter engine 6a is completed, the completion of the initialization of the plotter engine 6a is reported to the controller control unit 30. The controller control unit 30 notifies the print application of establishment of the engine-off transition.

Subsequently, the print application issues the engine-off transition response relative to the controller control unit 30.

When the recovery of the plotter engine 6a from the power-saving state is completed, the engine state is reported to the controller control unit 30. The controller control unit 30 notifies the power-saving monitoring driver DVa of the recovery from the power-saving. The driver notifies the power-saving monitoring system 22a of the start of recovery.

Accordingly, the power-saving monitoring system 22a switches the state of power from the power-saving state to the normal power state. The power-saving monitoring system 22a issues the power-saving recovery response to the controller control unit 30.

Accordingly, the image forming apparatus returns to the normal power state. Thereafter, a normal operation sequence is performed, and the print processing is executed.

According to the exemplary embodiments, when receiving the print data during the suspended state ST5, the power of the plotter engine 6a and the power of the fixing heater are turned on. Accordingly, time necessary for the temperature of the fixing heater to rise to a predetermined fixing temperature after receiving the print data can be reduced, compared with turning on the power of the fixing heater after the controller control unit 30 establishes communication with the plotter engine 6a as in the related art. Thus, the recovery time from the suspended state ST5 can be reduced.

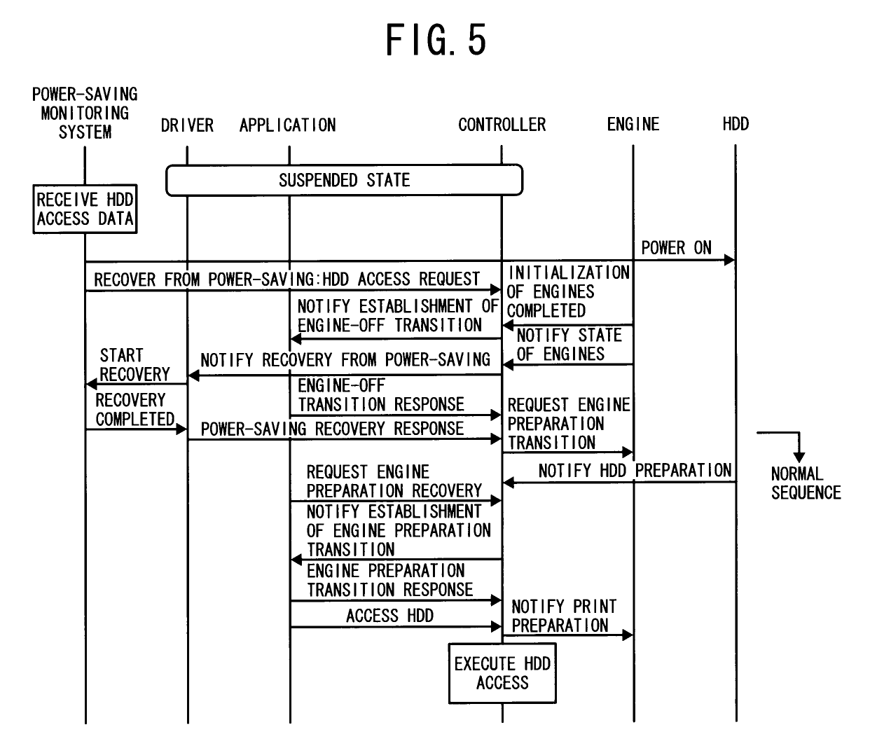

Furthermore, in the suspended state ST5, when, for example, receiving a request to access the magnetic disk device 9 because the file access function provided by the Web server function is accessed from outside, the operation state returns from the suspended state ST5 in accordance with a sequence as shown in FIG. 5, thereby enabling access to the magnetic disk device 9.

First, when the power-saving monitoring system 22a receives the request to access the magnetic disk device 9 from the network transmission driver DVf, the power-saving monitoring system 22a turns on the magnetic disk device 9.

Subsequently, the power-saving monitoring system 22a notifies the controller control unit 30 of “RECOVER FROM POWER-SAVING: PRINT REQUEST IS MADE.”

Accordingly, each engine is initialized. When the initialization of each engine is completed, the controller control unit 30 is notified of the completion of the initialization of the engines. The controller control unit 30 notifies the Web server application of the establishment of the engine-off transition.

Subsequently, the Web server application issues the engine-off state transition response relative to the controller control unit 30.

Furthermore, when the recovery of the engines from the power-saving state is completed, the state of the engines is reported to the controller control unit 30. The controller control unit 30 notifies the power-saving monitoring driver DVa of the recovery from the power-saving. The driver notifies the power-saving monitoring system 22a of the start of the recovery.

Accordingly, the power-saving monitoring system 22a switches the state of power from the power-saving state to the normal power state. The power-saving monitoring system 22a issues the power-saving recovery response to the controller control unit 30.

Accordingly, the image forming apparatus returns to the normal power state. Thereafter, the normal operation sequence is performed, and the access operation to the magnetic disk device 9 is executed.

According to the exemplary embodiments, when receiving the request to access the magnetic disk device 9 during the suspended state ST5, the power of the magnetic disk device 9 is turned on. Accordingly, the magnetic disk device 9 can return to an accessible state in a significantly short period of time, compared with returning power of the functions including the engines as well as the operation unit even though the access to the magnetic disk device 9 is requested by the user.

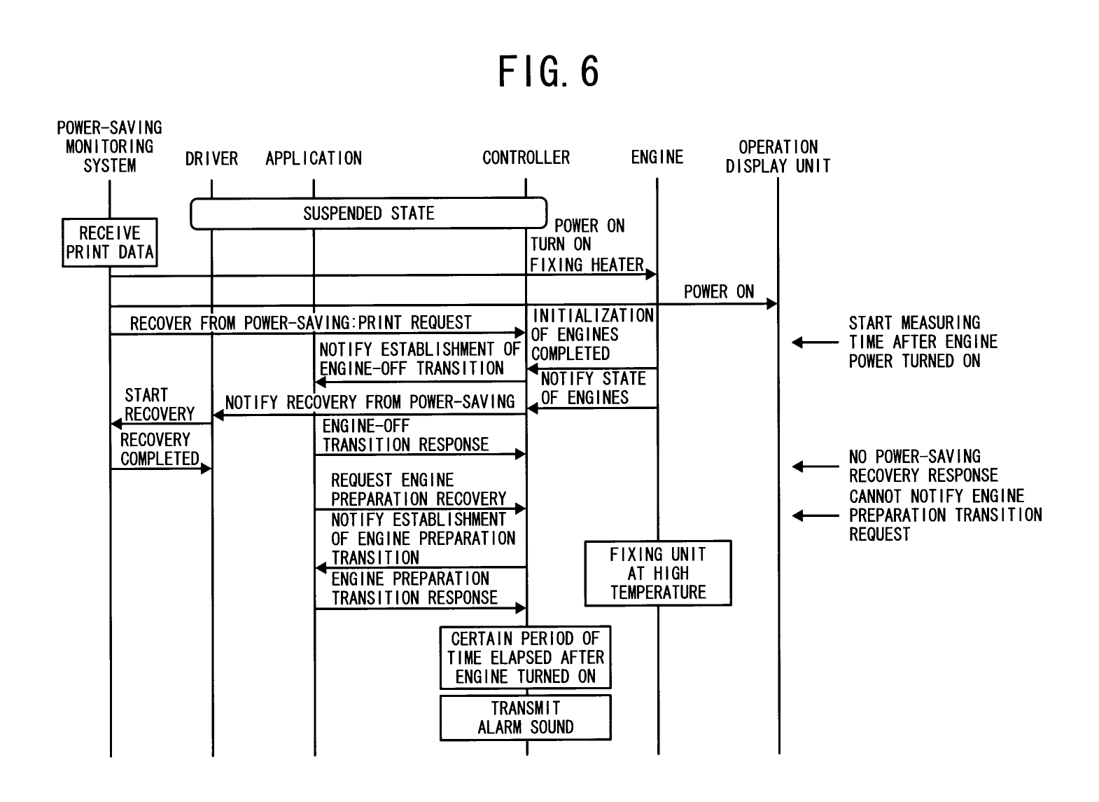

Referring now to FIG. 6, there is provided a sequence diagram illustrating one example of a recovery operation from the suspended state ST5 when the power-saving monitoring system 22a enters an abnormal state during the recovery operation. It should be noted that an overall sequence is similar to, if not the same as, that of FIG. 4. Thus, a detail description thereof is omitted herein.

In FIG. 6, the print data is received during the suspended state ST5, and thus the operation state is recovered from the suspended state ST5. However, the power-saving monitoring system 22a enters an abnormal state.

In such a case, the power-saving monitoring system 22a activates the fixing heater after receiving the print data. Consequently, the controller control unit 30 returned from the power-saving state needs to control the fixing heater so as to prevent the temperature of the fixing heater from getting too high.

When the recovery from the power-saving state is erroneously performed during transition to the controller control unit 30, and the power-saving recovery processing is not completed within a certain period of time after the controller control unit 30 returns from the power-saving, the control display unit 8 alerts the user with an alarm sound.

When the user is alerted with the alarm sound, the user is asked to turn off the main power of the image forming apparatus. Accordingly, the temperature rise of the heater is suppressed.

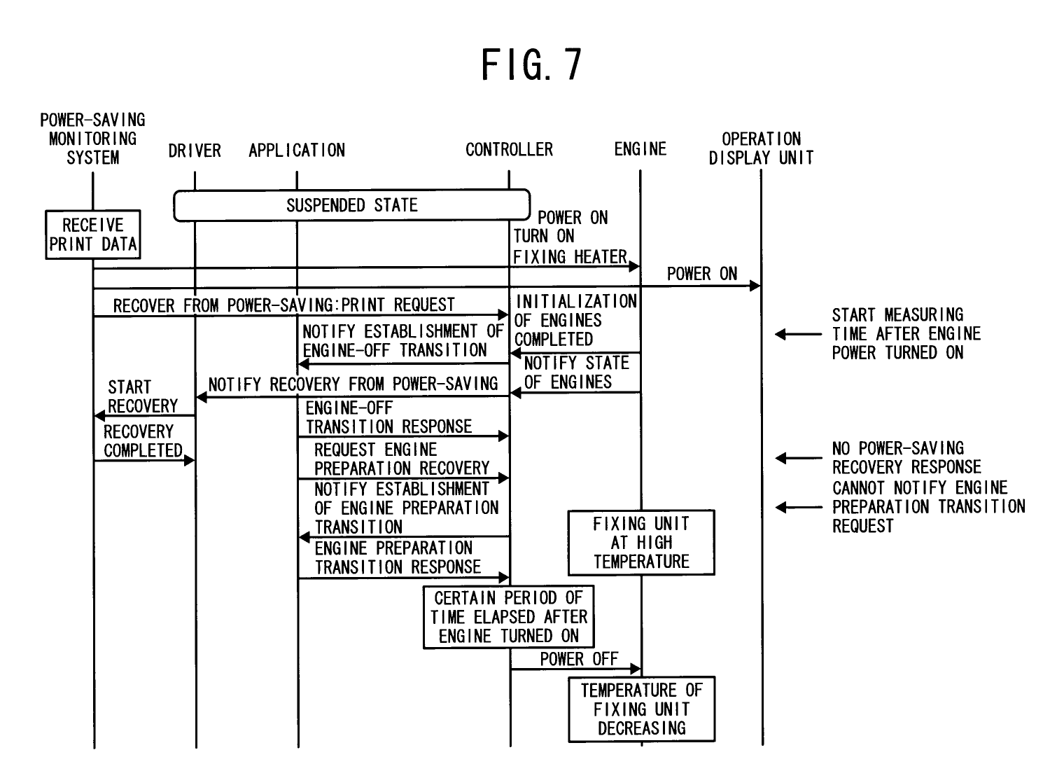

Referring now to FIG. 7, there is provided a sequence diagram illustrating another example of a recovery operation from the suspended state ST5 when the power-saving monitoring system 22a enters an abnormal state during the recovery operation. It should be noted that an overall sequence is similar to, if not the same as, that of FIG. 4. Thus, a detail description thereof is omitted herein.

In FIG. 7, the print data is received during the suspended state ST5, and thus the operation state is recovered from the suspended state ST5. However, the power-saving monitoring system 22a enters an abnormal state.

In such a case, the power-saving monitoring system 22a activates the fixing heater after receiving the print data. Consequently, the controller control unit 30 returned from the power-saving state needs to control the fixing heater so as to prevent the temperature of the fixing heater from getting too high.

When the recovery from the power-saving state is erroneously performed during transition to the controller control unit 30, and the power-saving recovery processing is not completed within a certain period of time after the controller control unit 30 returns from the power-saving, the image forming apparatus turns off the fixing heater so as to prevent the temperature of the heater from rising.

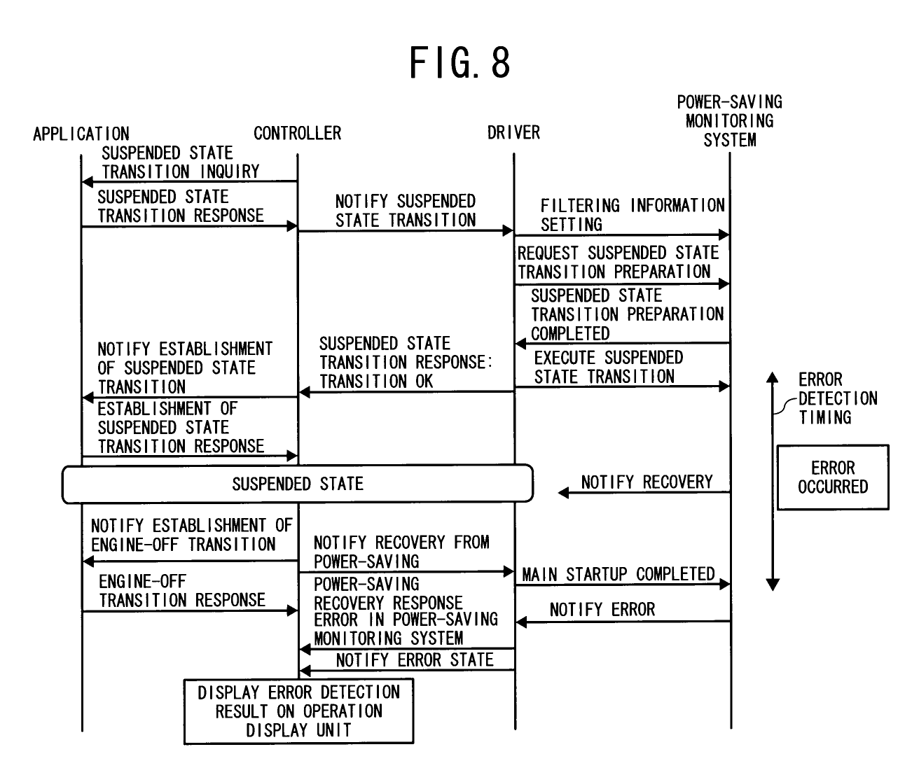

In the event that the power-saving monitoring system 22a itself fails, one example of an operation is provided in FIG. 8.

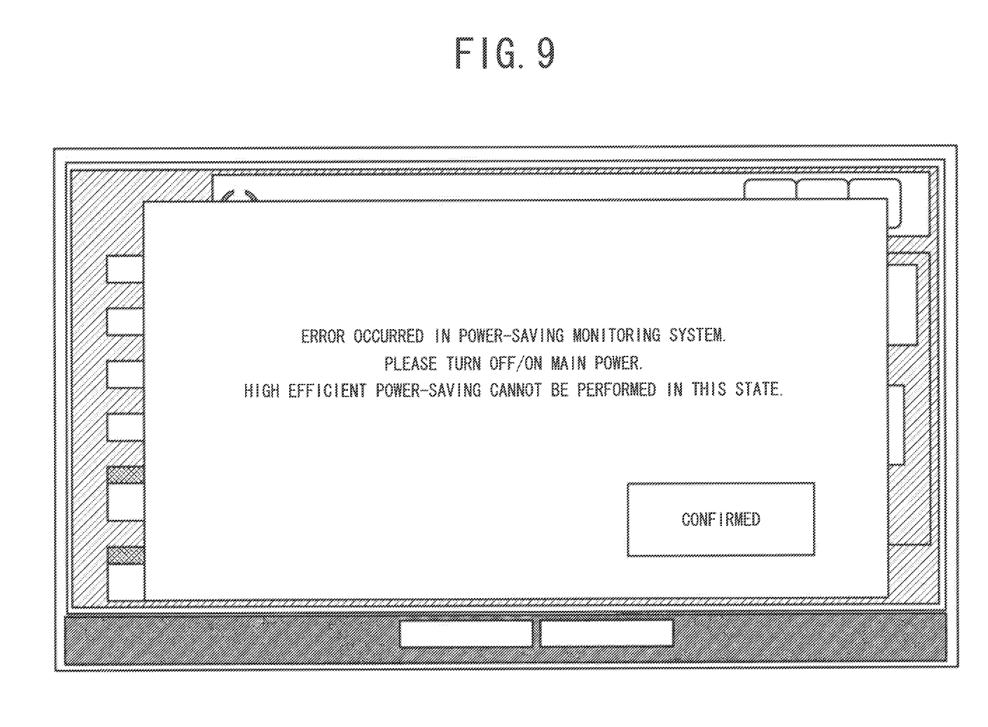

When an error occurs in the power-saving monitoring system 22a, the image forming apparatus is not able to switch to the suspended state. When the image forming apparatus can return from the power-saving state, the image forming apparatus may recover to the standby state and display an alert message on an alert screen as shown in FIG. 9 in order to inform the operation display unit 8 that the error occurred in the power-saving monitoring system 22a.

Accordingly, the operation display unit 8 can notify the user of the error so that the user may become aware of the error, and determine whether the power-saving setting set by the user is performed.

According to the exemplary embodiments, during the power-saving state the power-saving monitoring system 22a is configured to independently recover functions from the power-saving state to the normal power state so that the function needed by the user can be returned from the power-saving state to the normal power state.

Furthermore, the print function and the recording medium control function (the function for accessing the magnetic disk device 9) can be returned from the power-saving state to the normal power state. Accordingly, it is possible to reduce the time needed for the image forming apparatus to return from the power-saving state to the normal power state.

When the power-saving monitoring system 22a receives data requesting access to the recording medium (the magnetic disk device 9), the recording medium control function (the function for accessing the magnetic disk device 9) can return from the power-saving state to the normal power state. Accordingly, the necessary function to accommodate the user operation can be returned from the power-saving state to the normal power state, and the recovery time can be reduced as well.

One or more embodiments of the present invention may be employed not only in the image forming apparatus, but also in the field of controlling the image forming apparatus and the power-saving, and the startup time for the image forming apparatus.

Furthermore, elements and/or features of different exemplary embodiments may be combined with each other and/or substituted for each other within the scope of this disclosure and appended claims.

The number of constituent elements, locations, shapes and so forth of the constituent elements are not limited to any of the structure for performing the methodology illustrated in the drawings.

Still further, any one of the above-described and other exemplary features of the present invention may be embodied in the form of an apparatus, method, system, computer program, and computer program product. For example, of the aforementioned methods may be embodied in the form of a system or device, including, but not limited to, any of the structure for performing the methodology illustrated in the drawings.

One or more embodiments of the present invention may be conveniently implemented using a conventional general purpose digital computer programmed according to the teachings of the present specification, as will be apparent to those skilled in the computer art.

Appropriate software coding can readily be prepared by skilled programmers based on the teachings of the present disclosure, as will be apparent to those skilled in the software art.

One or more embodiments of the present invention may also be implemented by the preparation of application specific integrated circuits or by interconnecting an appropriate network of conventional component circuits, as will be readily apparent to those skilled in the art.

Any of the aforementioned methods may be embodied in the form of a system or device, including, but not limited to, any of the structure for performing the methodology illustrated in the drawings.

Furthermore, any of the aforementioned methods may be embodied in the form of a program. The program may be stored on a computer readable media and is adapted to perform any one of the aforementioned methods, when run on a computer device (a device including a processor). The program may include computer executable instructions for carrying one or more of the steps above and/or more aspects of the invention.

Thus, the storage medium or computer readable medium is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of a built-in medium include, but are not limited to, rewriteable non-volatile memories, such as ROMs and flash memories, and hard disks.

Examples of a removable medium include, but are not limited to, optical storage media such as CD-ROMs and DVDs; magneto-optical storage media, such as MOs; magnetism storage media, such as floppy disks (registered trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such exemplary variations are not to be regarded as a departure from the spirit and scope of the present invention, and all such modifications as would be obvious to one skilled in the art are intended to be included within the scope of the following claims.

What is claimed is:

1. An image forming apparatus, comprising:
an operation display unit configured to accept operating input through operation keys and display devices;
a print unit configured to perform a printing operation;
a reading unit configured to read a document image;
a recording medium configured to temporarily store an image and information;
a recording medium controller configured to control the recording medium;
a network unit configured to enable the image forming apparatus to communicate with an external device;
a user operation detector configured to detect operation by the user; and
a power-saving controller independently supplied with power, configured to control a power-saving function of the image forming apparatus,
wherein the power-saving controller is configured to independently recover functions of the image forming apparatus from a power-saving state to a normal power state.

2. The image forming apparatus according to claim 1, wherein the power-saving controller is configured to return the print unit and the recording medium controller from the power-saving state to the normal power state when receiving data including a print request through the network unit.

3. The image forming apparatus according to claim 1, wherein the power-saving controller is configured to return the recording medium controller from the power-saving state to the normal power state when receiving data including a request to access the recording medium through the network unit.

4. The image forming apparatus according to claim 1, wherein the power-saving controller is configured to transmit an alarm when an error occurs when returning the print unit from the power-saving state to the normal power state.

5. The image forming apparatus according to claim 4, wherein the power-saving controller is configured to stop a heating operation of a heating element of the print unit when an error occurs when returning the print unit from the power-saving state to the normal power state.

6. The image forming apparatus according to claim 1, further configured, when the power-saving controller enters an abnormal state during the power-saving state, to return from the power-saving state to the normal power state and display the abnormal state on the operation display unit.

7. A method for controlling an image forming apparatus, comprising:
accepting operating input through operation keys and display devices;
performing a printing operation;
reading a document image;
storing temporarily an image and information;
controlling the storing;
communicating with an external device;
detecting an operation by user; and
controlling a power-saving function of the image forming apparatus while independently supplied with power,
wherein the controlling includes independently returning functions of the image forming apparatus from a power-saving state to a normal power state.

8. The method according to claim 7, wherein the controlling the power-saving function further comprises transmitting an alarm and stopping a heating operation of a heating element of the print unit when an error occurs when returning the print unit from the power-saving state to the normal power state.

9. The method according to claim 7, further comprising:
when the controlling the power-saving function enters an abnormal state during the power-saving state, returning the image forming apparatus from the power-saving state to the normal power state and displaying the abnormal state on an operation display unit.

10. An image forming apparatus, comprising:
operation display means for accepting operating input through operation keys and display devices;
print means for performing a printing operation;
reading means for reading a document image;
recording means for temporarily store an image and information;
recording medium control means for controlling the recording means;
network means for communicating with an external device;
operation detection means for detecting operating input; and
power-saving control means independently supplied with power for controlling a power-saving function of the image forming apparatus,
wherein the power-saving control means independently returns functions of the image forming apparatus from a power-saving state to a normal power state.
